(19) United States
(12) Patent Application Publication
(10) Pub. No.: US 2024/0426517 A1
(43) Pub. Date: Dec. 26, 2024

(54) SOLAR RECEIVER SYSTEMS AND METHODS OF USE

(71) Applicant: Dimensional Energy, Inc., Ithaca, NY (US)

(72) Inventors: Bradley J. Brennan, Omaha, NE (US); Jason Salfi, Little Compton, RI (US); Howard M. Branz, Boulder, CO (US); Joerg Petrasch, East Lansing, MI (US)

(73) Assignee: Dimensional Energy, Inc., Ithaca, NY (US)

(21) Appl. No.: 18/703,026

(22) PCT Filed: Oct. 20, 2022
(86) PCT No.: PCT/US2022/047242

§ 371 Date: Apr. 19, 2024

Related U.S. Application Data
(60) Provisional application No. 63/257,985, filed on Oct. 20, 2021.

(51) Int. Cl. F24S 10/80; B01J 19/00; B01J 19/30; F24S 20/20; F24S 20/30; F24S 50/80; F24S 60/00

(52) U.S. Cl. CPC F24S 10/80; B01J 19/0013; B01J 19/30; F24S 20/20; F24S 20/30; F24S 50/80; F24S 60/00; B01J 2219/00103; B01J 2219/00144; B01J 2219/32

(57) ABSTRACT

The inventive systems include solar receivers that are used to heat chemical reactors (110, 310). When solar radiation is plentiful. the systems utilize the solar radiation to heat chemical reactors (110, 310) and store excess heat from the solar radiation in a heat storage component (104, 702). When solar radiation is not plentiful. the systems heat the chemical reactors (110, 310) using heat stored in the heat storage component (104, 702). Also described are methods of using and methods of constructing such systems.

### BACKGROUND

The chemical and energy industries consume and produce a large variety of chemical compounds. Many of these compounds are produced using endothermic reactions, which means that a source of heat is often needed to sustain the reaction process.

Traditionally, the heat needed to drive such endothermic reactions has been generated by burning fossil fuels. However, solar receivers and/or collectors have also been employed to collect and concentrate solar radiation from the sun. Such solar-based heat sources are advantageous from environmental and cost standpoints but often suffer from intermittency issues that require diurnal cycling of such chemical reactors. If the sun is not shining (e.g., at nighttime or during periods of inclement weather), the prior art solar radiation heat sources may not be sufficient to sustain an endothermic reaction scheme reliably and cost-effectively at industrial scales.

A need exists for improved systems and methods that use solar energy to heat chemical reactors.

### SUMMARY

The present invention is directed towards systems and method relating to the use of solar energy to heat chemical reactors.

In some embodiments, the present invention includes systems for controlling the temperature of a chemical reactor. In some embodiments, the inventive systems include a solar assembly, a heat storage component, and a heat transfer fluid line. In some embodiments, the solar assembly includes a foam component, an insulative component, a solar absorption chamber, a reactor chamber, and a reactor positioned in the reactor chamber. In some embodiments, the insulative component defines at least a portion of an insulated receptacle and the foam component is positioned in the insulated receptacle. In some embodiments, at least a portion of the solar absorption chamber is defined by the foam component and an aperture, wherein the aperture is configured to allow solar radiation to enter the solar absorption chamber. In some embodiments, the foam component defines at least a portion of the reactor chamber. In some embodiments, the solar absorption chamber is in fluid communication with the heat storage component. In some embodiments, the heat transfer fluid line is in fluid communication with both the insulated receptacle and the heat storage component. In some embodiments, the inventive systems include a heat transfer fluid.

In some embodiments, the present invention includes methods of heating a reactor. In some embodiments, the inventive methods comprise providing one of the systems described herein for controlling the temperature of a chemical reactor. When solar radiation is available, the method includes heating the reactor by directing the solar radiation through the aperture to insolate and heat the solar absorption chamber, directing heat transfer fluid through the aperture and into the solar absorption chamber, directing the heat transfer fluid from the solar absorption chamber and through the foam component to heat the reactor, and directing the heat transfer fluid from the foam component and to the heat storage component to heat the heat storage component with the heat transfer fluid. When solar radiation is not available, the method includes heating the reactor by directing the heat transfer fluid to the heat storage component to heat the heat transfer fluid and directing the heat transfer fluid to the solar assembly from the heat storage component and through the foam component to heat the reactor.

In some embodiments, the present invention includes methods of manufacturing a system for controlling the temperature of a chemical reactor, wherein the system is a system as described herein. The method can include manufacturing one or more portions of the system using a 3D printing method.

### BRIEF DESCRIPTION OF THE DRAWINGS

In the drawings, which are not necessarily, drawn to scale, like numerals may describe similar components in different views. The drawings illustrate generally, by way of example, but not by way of limitation, various embodiments discussed herein.

FIG. 1 provides a perspective illustration of one embodiment of an inventive system.

FIG. 2A and 2B provide cross-sectional side views of a portion of one embodiment of the present invention.

FIGS. 3A and 3B provide cross-sectional side views of a portion of one embodiment of the present invention.

FIG. 4 provides a cross-sectional side view of a portion of one embodiment of the present invention.

FIGS. 5A and 5B provide cross-sectional side views of a portion of one embodiment of the present invention.

FIG. 6 provides a cross-sectional side view of a portion of one embodiment of the present invention.

FIG. 7 provides a schematic representation of a portion of one embodiment of the present invention.

FIG. 8 provides a schematic flow chart of one embodiment of the present invention.

FIG. 9 provides a schematic flow chart of one embodiment of the present invention.

### DETAILED DESCRIPTION

The present invention is directed towards systems for controlling the temperature of a chemical reactor, methods of using such systems, and methods of constructing such systems.

When sunlight is available (e.g., during day-light hours), the inventive systems use a solar assembly to convert solar energy to heat and use that heat to warm one or more chemical reactors and a heat storage component. When sunlight is not available (e.g., at night or when sunlight is obstructed), the inventive systems use the heat from the heat storage component to continue warming the chemical reactor(s). Hence, the inventive systems can warm chemical reactors using the sun's solar energy, even when sunlight is not available. In this way, the inventive systems can harness solar energy for both diurnal and nocturnal warming of chemical reactors and thereby minimize thermal cycling of the reactor components.

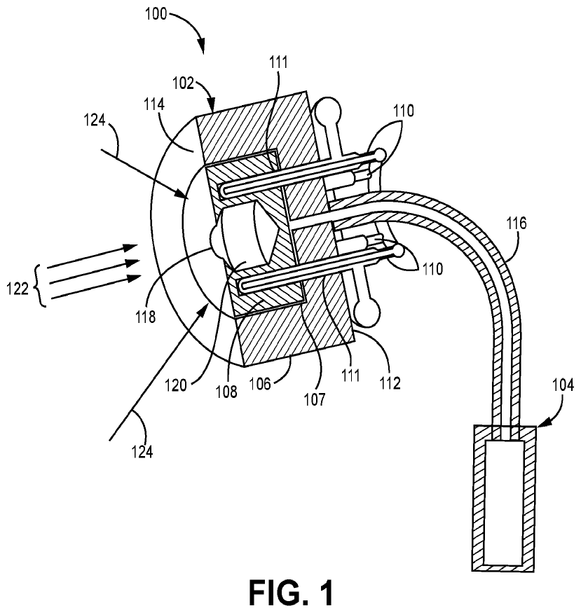

FIG. 1 provides a perspective illustration of one embodiment of a system of the present invention in the form of system 100, which shows a side cut-away view as well as a view of the front face of a solar assembly.

System 100 includes solar assembly 102 and heat storage component 104. Solar assembly 102 includes insulative component 106 and foam component 108. Solar assembly 102 also includes a plurality of chemical reactors 110 and reactor chambers 111. Each chemical reactor 110 is positioned within one of reactor chambers 111. Reactor chambers 111, as well as chemical reactors 110 positioned therein, extend from back face 112 of solar assembly 102 towards sunward or front face 114 of solar assembly 102. Reactor chambers 111 extend through insulative component 106 and partially through foam component 108. System 100 also includes heat transfer fluid line 116, which provides for fluid communication of heat transfer fluid between solar assembly 102 and heat storage component 104. Foam component 108 defines aperture 118 and solar absorption chamber 120.

During the day, solar radiation 122, such as solar radiation from a concentrating solar dish mirror or array of mirrors (not shown in FIG. 1), and air 124 are directed into solar assembly 102 through aperture 118 and into solar absorption chamber 120. Once in solar absorption chamber 120, solar radiation 122 insolates surfaces defining solar absorption chamber 120 (e.g., the surfaces of foam component 108), thereby heating those surfaces and the solar absorption chamber 120. Air 124 enters solar absorption chamber 120 and is in turn warmed by those insolated surfaces.

System 100 uses air 124 as a heat transfer fluid. After being heated in solar absorption chamber 122, the resulting hot air 124 is directed from solar absorption chamber 122 and through foam component 108 via an interconnected porous network (not illustrated in FIG. 1) defined in or by foam component 108. Reactors 110 are warmed by conduction of heat from foam component 108 and/or the heated air 124 as air 124 travels through foam component 108.

Once air 124 has passed through or by foam component 108, then hot air 124 is directed through heat transfer fluid line 116 to heat storage component 104. Heat storage component 104 is also warmed by the heated air 124 as air 124 passes into and through heat storage component 104.

At night, when solar radiation 122 is insufficient to warm reactors 110, system 100 runs in reverse by directing air through heat storage component 104. As the air passes through heat storage component 104 the air is warmed using the heat stored there during the day when solar radiation 116 was available. The warmed air is directed from heat storage component 104 and to solar assembly 102 via heat transfer fluid line 116. Once in solar assembly 102, the warm air passes through the interconnected porous network defined in foam component 108 and warms reactors 110 positioned within reactor chambers 111.

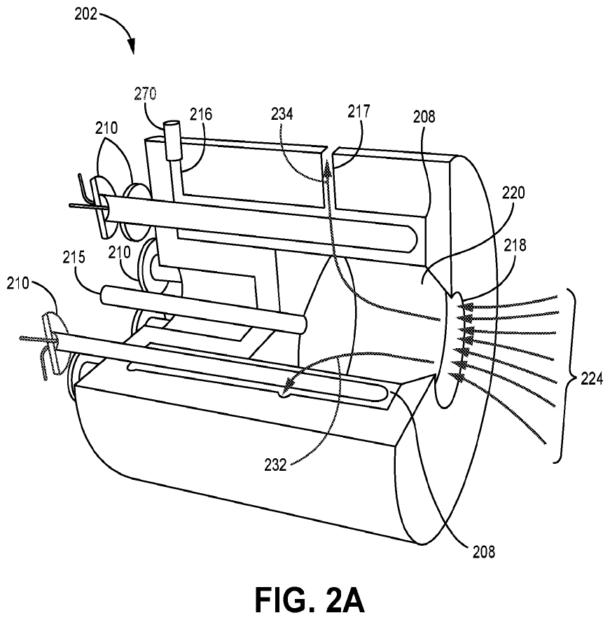

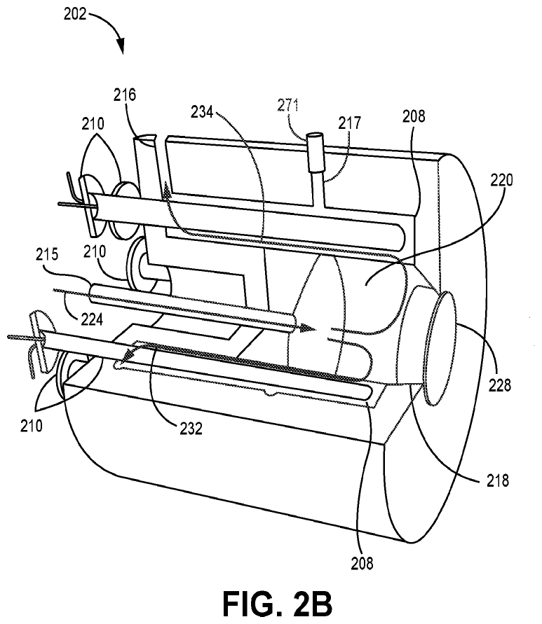

FIGS. 2A and 2B illustrate a cross-section side view and sunward face of one embodiment of the present invention in the form of solar assembly 202. FIGS. 2A and 2B respectively illustrate the flow of heat transfer fluid 224 through solar assembly 202 when the inventive system is harnessing solar radiation to heat its reactors 210 (e.g., during the day) and when the inventive system is harnessing heat stored in a heat storage component (e.g. during the night; heat storage component not shown in FIGS. 2A or 2B).

When solar radiation is plentiful, solar assembly 202 operates as depicted in FIG. 2A. FIG. 2A illustrates the flow path that heat transfer fluid 224 may take as it travels through solar assembly 202. When solar radiation is plentiful, aperture 218 is open, allowing solar radiation (not illustrated in FIGS. 2A or 2B) to enter and insolate the walls of foam component 208 that define solar absorption chamber 220, thereby warming foam component 208 and solar absorption chamber 220. Relatively cold heat transfer fluid 224, in the form of atmospheric air, also enters solar absorption chamber 220 via aperture 218. When heat transfer fluid 224 enters chamber 220, heat transfer fluid 224 is heated by the insolated walls defining solar absorption chamber 220. After being heated in solar absorption chamber 220, heat transfer fluid 224 is directed through foam component 208 via an interconnected porous network defined within foam component 208. Arrows 232 and 234 in FIG. 2A illustrate general flow paths that heat transfer fluid 224 follows as it passes from chamber 220 to and through foam component 208. As the hot heat transfer fluid 224 passes through the interconnected porous network within foam component 208, the hot heat transfer fluid 224 heats reactors 210. After passing through foam component 208, the still hot heat transfer fluid 224 is directed into heat transfer fluid line 217 (generally along the path followed by arrow 234 if FIG. 2A) which in turn directs heat transfer fluid 224 to a heat storage component (not shown in FIGS. 2A or 2B). Solar assembly 202 also includes heat transfer fluid lines 215 and 216, but lines 215 and 216 are closed or otherwise occluded (e.g., with valve or plug 270) when aperture 218 is open to ensure heat transfer fluid 224 will pass into heat transfer fluid line 217.

When solar radiation is not plentiful, solar assembly 202 operates as depicted in FIG. 2B. Insulated plug 228 is positioned within aperture 218, thereby preventing fluids from entering or leaving solar absorption chamber 220 via aperture 218 and further insulating solar absorption chamber 220 from heat loss to the environment. Rather than pass through aperture 218, heat transfer fluid 224 is first directed through the heat storage component to produce a hot heat transfer fluid 224. After heating, the hot heat transfer fluid 224 is directed into solar absorption chamber 220 via heat transfer fluid line 215. Hot heat transfer fluid 224 is then directed into or along foam component 208. As it passes through foam component 208 via the interconnected porous network defined therein, the hot heat transfer fluid 224 heats reactors 210. After passing through foam component 208, the still hot heat transfer fluid 224 is directed into heat transfer fluid line 216 which in turn vents heat transfer fluid 224 to the atmosphere, directs heat transfer fluid 224 to another application, or directs heat transfer fluid 224 back to the heat storage component to be reheated for further use in assembly 202. Arrows 232 and 234 in FIG. 2B illustrate the flow path of heat transfer fluid 224 as it passes from chamber 220 to and through foam component 208 and on its way to 216. When aperture 218 is closed by insulated plug 228, heat transfer fluid line 217 is also closed or otherwise occluded (e.g., with a valve or plug 271) to ensure heat transfer fluid 224 will pass into heat transfer fluid line 216.

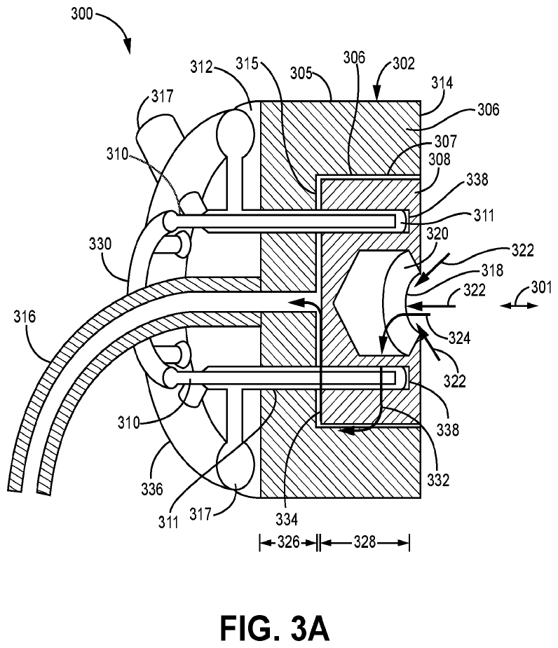

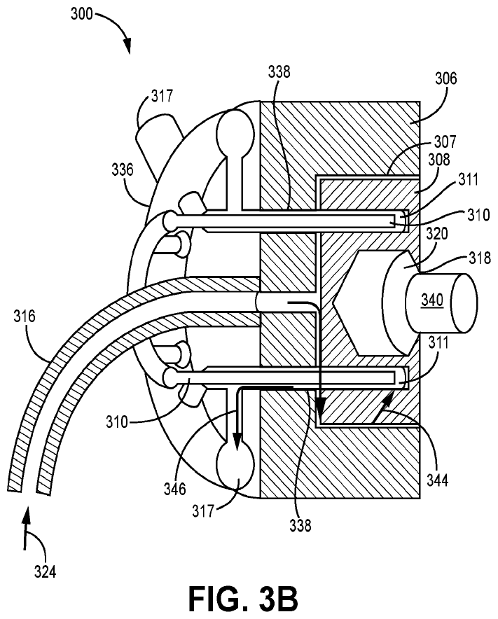

FIG. 3A illustrates a cut-away side view of a portion of another embodiment of the present invention in the form of system 300. System 300 includes solar assembly 302, a heat storage component (not shown in FIG. 3A), and heat transfer fluid line 316. Solar assembly 302 includes foam component 308, insulative component 306, and a plurality of chemical reactors 310. Solar assembly 302 is arranged coaxially with major central axis 301.

Insulative component 306 is arranged coaxially along major central axis 301 and is generally cylindrical in shape. Insulative component 306 includes outer tubular wall 305 extending between back face 312 and front face 314. Insulative component 306 also includes recessed front face 315 which defines the bottom surface of insulated receptacle 307 while inner tubular wall 309 define insulated receptacle 307 circumferentially. Insulative component 306 also defines a portion of heat transfer fluid line 316 extending between back face 312 and recessed front face 315. The portion of heat transfer fluid line 316 defined by insulative component 306 is positioned generally coaxial with major central axis 301 and extends for a length approximately equal to length 326. Heat transfer fluid line 316 is in fluid communication with the heat storage component and provides a means for heat transfer fluid 324 to leave or enter insulated receptacle 307.

Component 306 provides an insulating layer to assembly 302 to reduce or prevent loss of heat and heat transfer fluid from within receptacle 307 and reactors 310 during operation of system 300. The operating temperature within insulative component 306 can vary with a given application, but in some applications operating temperatures within receptacle 307 and other portions of assembly 302 may range from 50° C. to 2,000° C. The insulated receptacles of the present invention may be made of one or more materials that can withstand the operating conditions of interest. Examples of materials that may be useful as a material of construction for the insulative components of the present invention can include an insulative refractory material (e.g., oxides, carbides, or nitrides of silicon, aluminum, magnesium, calcium, boron, chromium, or zirconium), a ceramic material, a ceramic composite material, or combinations thereof. Further examples include silica, alumina, aluminosilicates, and/or zirconia.

Foam component 308 is also generally cylindrical in shape and is arranged co-axial along major central axis 301 within insulated receptacle 307 defined by insulative component 306. Foam component 308 defines solar absorption chamber 320 and aperture 318. Aperture 318 is a circular hole in the sunward or front face of foam component 308. While aperture 318 shown in FIG. 3A is circular in shape, in other embodiments, the apertures of the present invention may have other shapes (e.g., an ovular, rectangular, square, hexagonal, or other rectilinear shape).

The lateral sides of solar absorption chamber 320 (i.e., the sides of solar absorption chamber 320 that extend roughly parallel to central axis 301) define a tubular shape that is coaxial with foam component 308, insulative component 306, and major central axis 301. While the lateral sides of solar absorption chamber 320 shown in FIG. 3A are generally tubular in shape with a circular cross-sectional profile, in other embodiments, the solar absorption chamber of the inventive systems can have other shapes and cross-sectional profiles, such as ovular, square, rectangular, hexagonal, or other rectilinear shapes.

The bottom or back side of solar absorption chamber 320 (i.e., the side of solar absorption chamber 320 closest to recessed front face 315 of insulative component 306) has a conical shape. While the back side of solar absorption chamber 320 shown in FIG. 3A is conical in shape, in other embodiments, the back side of the solar absorption chambers of the inventive systems have other shapes, such as a flat surface or a rounded spherical shape or dome that is either convex or concave relative to aperture 318. Further, the back side of the solar absorption chambers of the inventive system may be formed by a plurality of facetted flat surfaces such that the back side forms a regular pyramidal shape with an apex on central major axis 301 that is orientated towards or away aperture 318.

Foam component 308 defines an interconnected porous network (not illustrated in FIG. 3A) that provides fluidic flow paths that allow heat transfer fluid 324 to pass through foam component 308. In some embodiments, the interconnected porous network does not extend into the portions of foam component 308 that are near and/or define front face 314 so as to prevent heat transfer fluid from passing through the front face 314 of assembly 302. In further embodiments, the front face of a foam component of the present invention is covered with a solid piece of material that plugs or otherwise occludes the interconnected porous network in the portions of the foam component that define the sunward facing side.

The foam components of the present invention may be made from a material that can withstand the operating conditions of interest. In some embodiments, the foam component is made of a material that readily conducts heat. Some examples of materials that may be useful as a material of construction for the foam components of the present invention can include a metal or a metal alloy (e.g., a stainless-steel alloy, such as SS316, a chromium nickel alloy, such as 800HT and/or a molybdenum alloy such as Hastelloy Alloy X), a ceramic material, a ceramic composite material, or combinations thereof. Further examples include silicon carbide, aluminum nitride, aluminum oxynitride, and/or alumina. In still further examples, the materials are further modified with solar absorptive coatings, chemically inert or reactive coatings, or other coatings that improve or enhance one or more properties of the coated material.

Insulative component 306 and foam component 308 define portions of each of the plurality of reactor chambers 311. Each reactor chamber 311 is roughly tubular in shape. Each reactor chamber 311 extends from back face 312 of insulative component 306 to a point that is near or adjacent to front face 314 of foam component 308, along axes that are approximately parallel to major central axis 301. The length of the portion of each reactor chamber 311 defined by insulative component 306 is approximately equal to length 326 in FIG. 3A. The length of the portion of each reactor chamber 311 defined by foam component 308 is approximately equal to length 328 in FIG. 3A. The plurality of reactor chambers 311 are arranged symmetrically about major central axis 301, near the radial periphery of solar absorption chamber 320. One chemical reactor 311 is arranged in each of the plurality of reactor chambers 311. While the embodiment shown in FIG. 3A illustrates a plurality of reactors, each in its own reactor chamber, each extending symmetrically about and equidistance from major central axis 301 of assembly 302, and each extending approximately the same distance into foam component 308, in other embodiments, the inventive systems include a plurality of reactors and reactor chambers that are arranged differently. For example, in some embodiments, more than one reactor is positioned in each reactor chamber. Further, in some embodiments, the reactors and reactor chambers are positioned about the central axis in an asymmetric manner and/or at unequal distances from the major central axis of the assembly. Still further, in some embodiments, one or more of the reactors and reactor chambers are positioned such that they extend into the foam component of an inventive assembly a distance that is greater than or less than the distances that the other reactors and chambers extend.

The end of each chemical reactor 311 extending out from back face 312 is secured to reactor manifold 330. Manifold 330 defines one or more flow channels which supply reactors 311 with reactant species for use in the chemical reaction conducted within reactors 311 and/or remove product species from reactors 311. For example, each reactor in an inventive system may be secured to a reactant transport channel and a product transport channel that is positioned within or defined by a manifold.

Heat transfer fluid manifold 336 is secured to back face 312 of insulative component 306. Heat transfer fluid manifold 336 a plurality of reactor chamber portions 338 that are tubular in shape and each portion 338 defines a lumen extending along its inner length. Heat transfer fluid manifold 336 also defines a portion of heat transfer fluid line 317. One reactor chamber portion 338 extends into each of the plurality of reactor chambers 311, with each reactor 310 positioned coaxially with the tubular lumen defined by portion 338. Gaps between the inner walls of the tubular lumen defined by portions 338 and the outer surface of reactors 310 provide a flow channel for heat transfer fluid that is in fluid communication with heat transfer fluid line 317. Heat transfer fluid manifold 336 and heat transfer fluid line 317 provides a means for heat transfer fluid to enter or leave insulated receptacle 307.

The demands of a given application may dictate how many chemical reactors and reactor chambers are included in an inventive solar assembly. In some embodiments, the solar assemblies of the present invention include 1, 2, 3, 4, 5, 6, 7, 8, 9, 10, 11, 12, or more than 12 chemical reactors. Many different types of chemical reactors can be utilized with the present inventive systems. For example, chemical reactors described in PCT application number PCT/US22/18266, which is entitled “Heterogeneous Catalytic Reactors” and was filed on 1Mar. 2022, could be utilized in the present inventive systems. The entire contents of PCT application PCT/US22/18266 are incorporated herein by reference.

System 300 can be used to control the operating temperatures within chemical reactors 310. During use, one or more blowers (e.g., bi-directional blowers; not illustrated in FIG. 3A) are in fluid communication with heat transfer fluid line 316 and/or heat transfer fluid line 317. The blowers can create a pressure gradient within heat transfer fluid lines 316 and 317 so as to draw heat transfer fluid (e.g., atmospheric air) into and out of solar assembly 302 and through the heat transfer lines 316, 317, the interconnected porous network defined by foam component 308, and solar absorption chamber 320.

FIG. 3A illustrates system 300 at a time when solar radiation 322 is plentiful and solar radiation 322 and heat transfer fluid 324 are drawn into solar absorption chamber 320 through aperture 318 by the pressure gradient produced in heat transfer fluid line 316 by the one or more blowers. The path of heat transfer fluid 324 at a time when solar radiation 322 is plentiful is illustrated in FIG. 3 by the arrows denoted by element numbers 332 and 334. One or more valves (not shown in FIG. 3A) in heat transfer fluid line 316 are opened to allow heat transfer fluid 324 to flow therethrough, while one or more valves in heat transfer fluid line 317 are closed so as to prevent heat transfer fluid 324 from flowing through heat transfer fluid line 317.

Looking at FIG. 3A, solar radiation 322 insolates the walls of foam component 308 that define solar absorption chamber 320, thereby warming foam component 308. Heat transfer fluid 324 is drawn through aperture 318 and into solar absorption chamber 320 by the pressure gradient produced by the blower(s). Heat transfer fluid 324 is directed into the interconnected porous network defined by foam component 308. As heat transfer fluid 324 passes through solar absorption chamber 320 and comes into contact with foam component 308, it is warmed. Arrow 332 in FIG. 3A illustrates a path taken by the warmed heat transfer fluid 324 as it passes through foam component 308. As can be seen, the flow path of the warmed heat transfer fluid 324 passes near or next to the portions of reactors 310 that extend through foam component 308. The portions of reactors 310 positioned along length 328 are heated by heated foam component 308 as well as hot heat transfer fluid 324 as fluid 324 passes by or near reactors 310 on its way through foam component 308, travelling a path that roughly follows the path illustrated by arrow 332. Warm heat transfer fluid 334 then enters heat transfer fluid line 316, roughly following the pathway indicated by arrow 334 in FIG. 3A. Heat transfer fluid line 316 then directs the warm heat transfer fluid 334 to the heat storage component (not illustrated in FIG. 3A) where heat from fluid 334 is stored for later use.

FIG. 3B illustrates a perspective side cut-away view of system 300 as it operates during a time when solar radiation is not available. Aperture 318 is occluded by insulated plug 340, to prevent heat and heat transfer fluid from escaping solar absorption chamber 320 via aperture 318. The valve(s) (not illustrated in FIG. 3B) along heat transfer fluid line 317 are opened to allow heat transfer fluid to flow therethrough. The blower(s) (not illustrated in FIG. 3B) are again used to create a pressure gradient in heat transfer fluid lines 316, however the blowers are operated in reverse to direct heat transfer fluid 324 into insulated receptacle 307 from heat transfer line 316 and direct heat transfer fluid 324 out of insulated receptacle 307 via heat transfer line 317.

Looking at FIG. 3B, when solar radiation 322 is not available, heat transfer fluid 324 is directed through the heat storage component (not illustrated in FIG. 3B) to produce warmed heat transfer fluid 324. The warmed heat transfer fluid 324 is then directed into insulated receptacle 307 via heat transfer fluid line 316, roughly following the path indicated by arrow 338. Once in receptacle 307, heat transfer fluid 324 flows through foam component 308 via the interconnected porous network defined by component 308 and towards reactor chambers 311, roughly following the path indicated by arrow 344. When heat transfer fluid 324 reaches reactor chambers 311, it flows into the gap separating the inner tubular wall of reactor chamber portions 338 from the outer wall of reactors 310. From there, heat transfer fluid 324 flows along the length of inner tubular wall of reactor chamber portions 338 and through heat transfer fluid manifold 336 and heat transfer fluid line 317. Arrow 346 illustrates the flow path of heat transfer fluid 324 as it travels along reactor chamber portions 338, through heat transfer fluid manifold 336, and into heat transfer fluid line 317. Heat transfer fluid line 317 directs the heat transfer fluid 324 back to the heat storage component for reuse in system 300, vents fluid 324 out to the atmosphere, or directs fluid 324 to another application. As heat transfer fluid passes by or near reactors 310, heat transfer fluid 324 warms reactors 310.

While system 300 is illustrated having a single heat transfer fluid line directing heat transfer fluid into insulated receptacle 307 and a single heat transfer fluid line directing heat transfer fluid out of insulated receptacle 307 at a given time, in some embodiments, the inventive systems include more than one line directing heat transfer fluid into an insulated receptacle and/or more than one line directing heat transfer fluid out of an insulated receptacle at any given time. For example, the inventive systems may use 2, 3, 4, 5, 6, 7, 8, 9, 10, 11, 12, or more than 12 heat transfer fluid lines that are directing heat transfer fluid into or out of an insulated receptacle at any one given point of time. If a plurality of heat transfer fluid lines are utilized, they could, for example, be positioned such that they feed or remove heat transfer fluid from the insulated receptacle at various points about the outer wall(s), the back wall, or the front sunward face of the insulated component.

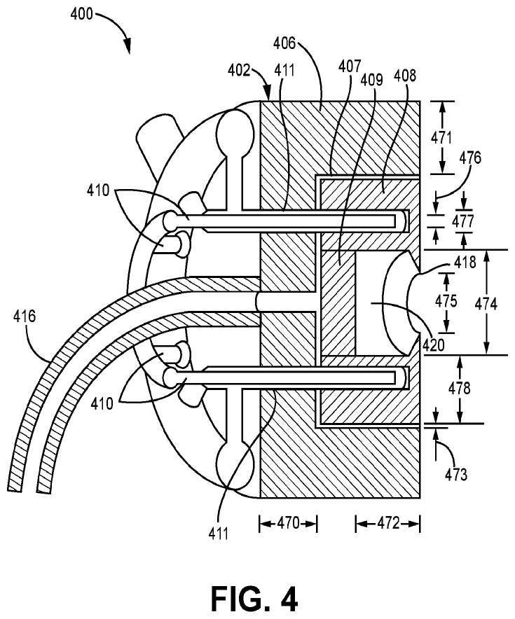

FIG. 4 illustrates a side cut-away view of another embodiment of the invention in the form of system 400. System 400 includes includes solar assembly 402, a heat storage component (not shown in FIG. 4), and heat transfer fluid line 416. Solar assembly 402 includes foam component 408, insulative component 406, a plurality of chemical reactors 410, a plurality of reactor chambers 411, solar absorption chamber 420, and aperture 418. Insulative component 406 defines insulated receptacle 407. Within insulative component 406 is positioned foam component 408 and block component 409. Block component 409 is a cylindrical structure positioned within receptacle 407 and coaxially with insulative component 406 and foam component 408. While block component 409 has a cylindrical shape, in other embodiments, the block component of the invention has a domed or semi-spherical shape that is either concave or convex relative to aperture 418.

Solar absorption chamber 420 is defined by the inner walls of foam component 408, block component 409, and aperture 418. Foam component 408 is made of a porous material and defines an interconnected porous network providing a flow path for heat transfer fluid to pass through foam component 408. Block component 409, on the other hand, may be made of the same or different material as foam component 408 and is substantially devoid of pores. Because block 409 lacks the interconnected porous network of foam component 408, block 409 prevents hot heat transfer fluid from following the shortest pathway to heat transfer fluid line 416 which is a direction that is roughly along the central axis of foam component 408 towards the point where heat transfer fluid line 416 is defined by insulated component 406. Block 409 forces the hot heat transfer fluid in solar absorption chamber 420 to first flow radially through the lateral sidewalls of foam component 408, thereby forcing more of the hot heat transfer fluid to flow past or near the plurality of reactors 410.

Still further, in some embodiments, the block components of the present inventions are made of a material that is relatively darker in color than the materials forming the foam component. The darker color of the block components facilitate better absorption of solar radiation entering a solar absorption chamber as compared to a lighter colored material.

The block components of the present invention may be made of a nonporous material that is the same or different than the materials used to form the foam components. In some embodiments, the block component and foam component are separate pieces of material, while in other embodiments, the block component and foam component are made from the same unitary pieces of material except that the portions of the one or more pieces of material that form the block component are devoid of a porous network while the one or more pieces of material that form the foam component define interconnected porous networks.

The dimensions of the various components of the present inventive systems can be adjusted to a desired size based on the needs of a given application. FIG. 4 illustrate some of those dimensions. Length 470 corresponds to the width of the back wall of insulative component 406, while length 471 corresponds to the width of the side walls of insulative component 406. Length 472 corresponds to the depth of solar chamber 420 (i.e., the distance from the sunward face of block component 409 defining the bottom of solar absorption chamber 420 to aperture 418). Length 473 corresponds to the width of the gap between the foam component 408 and the insulative component 406 (i.e., distance between the surface of the outer side wall of foam component 408 and the opposing inner side wall of insulative component 406 that defines the sides of insulated receptacle 407). Length 474 corresponds to the diameter of solar absorption chamber 420 (i.e., the distance between the opposing inner surfaces of the side walls of foam component 408 that define a portion of chamber 420). Length 475 corresponds to the diameter of aperture 418. Length 476 corresponds to the diameter of reactors 410, while length 477 corresponds to the diameter of reactor chambers 411. Length 478 corresponds to the width of the side walls of foam component 408.

In some embodiments of the invention, any of lengths 470, 471, and 472 are between ˜100 mm and ˜300 mm (e.g., ˜200 mm). In some embodiments of the invention, length 473 is between ˜0 mm and ˜50 mm (e.g., ˜25 mm). In some embodiments of the invention, length 474 is between ˜300 mm and ˜900 mm or about 150% of length 475. In some embodiments of the invention, length 475 is between ˜200 mm and ˜600 mm (e.g., ˜400 mm). In some embodiments of the invention, length 476 is between ˜25 mm and 75 mm (e.g., ˜50 mm). In some embodiments of the invention, length 477 is between ˜25 mm and ˜150 mm. In some embodiments of the invention, length 478 is between ˜50 mm and ˜200 mm (e.g., ˜125 mm). In further embodiments of the invention, any of lengths 470, 471, and 472 or any of the other dimensions of the inventive systems can be scaled to a desired size based on the needs of a given application.

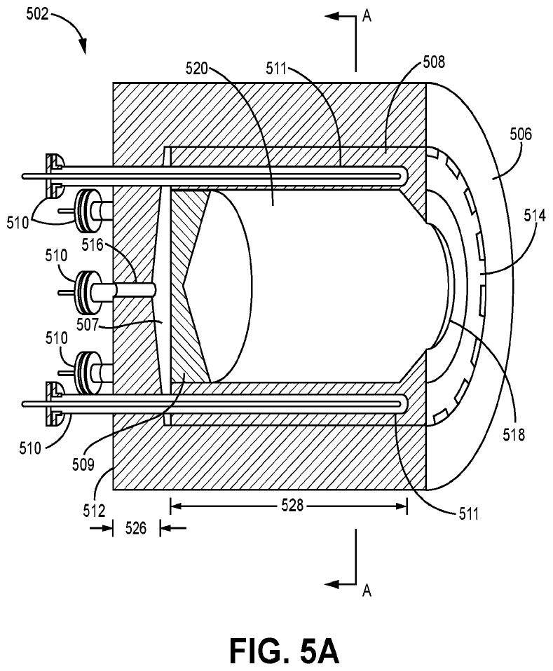

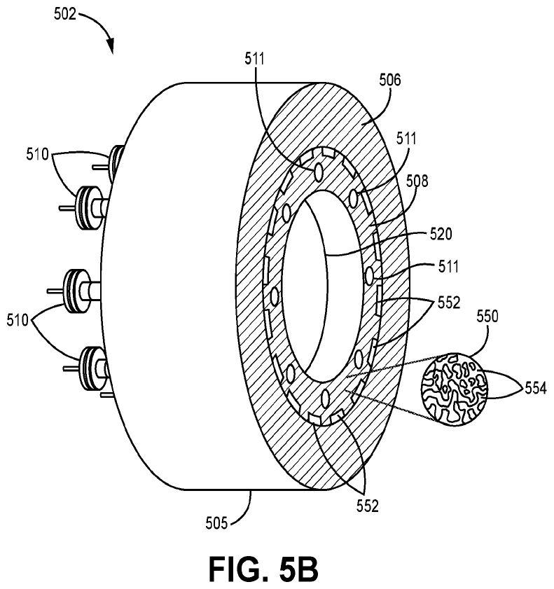

FIG. 5A illustrate a side cut-away perspective view of a portion of another embodiment of the present invention in the form of solar assembly 502. Solar assembly 502 includes insulative component 506, foam component 508, and a plurality of chemical reactors 510. Insulative component 506 defines insulated receptacle 507 inside of which is positioned foam component 508 and block component 509. Sunward face 514 of foam component 508 defines aperture 518. Solar absorption chamber 520 is at least partially defined by aperture 518, foam component 508, and block component 509.

Foam component 508 and insulative component 506 each at least partially define a plurality of reactor chambers 511. Insulative component 506 defines a portion of each of the plurality of reactor chambers 511 that extends from back wall 512 to the back wall of solar absorption chamber 520, which portion is approximately parallel to and equal to the length of line 526. Foam component 508 also defines a portion of each of the plurality of reactor chambers 511 that extends from the back wall of foam component 508 to a position that is near sunward face 514 of foam component 508, which portion is approximately parallel to and equal to the length of line 528.

Insulative component 506 also defines a portion of heat transfer fluid line 516 which provides a means of fluid communication between assembly 502 and a thermal storage component (not illustrated in FIGS. 5A and 5B).

FIG. 5B illustrates a perspective view of one side of solar assembly 502 with a cross-section view along line AA in FIG. 5A. The view in FIG. 5B illustrates that foam component 508 defines at least the tubular walls of solar absorption chamber 520. Foam component 508 also defines an interconnected porous network 554, which are illustrated in magnified portion 550. Foam component 508 also defines at least a portion of a plurality of heat transfer channels 552, which are arranged between the outer circumference of foam component 508 and the inner wall of insulative component 506. In some embodiments, heat transfer channels 552 are larger in size than interconnected porous network 554 of the interconnected porous network. In some embodiments, the heat transfer channels of the invention have a diameter or width of ˜0.01 cm, ˜0.05 cm, ˜0.10 cm, ˜0.15 cm, ˜0.20 cm, ˜0.25 cm, ˜0.30 cm, ˜0.35 cm, ˜0.40 cm, ˜0.45 cm, ˜0.50 cm, ˜0.55 cm, ˜0.60 cm, ˜0.65 cm, ˜0.70 cm, ˜0.75 cm, ˜0.80 cm, ˜0.85 cm, ˜0.90 cm, ˜0.95 cm, ˜1.0 cm, ˜1.1 cm, ˜1.2 cm, ˜1.3 cm, ˜1.4 cm, ˜1.5 cm, ˜1.6 cm, ˜1.7 cm, ˜1.8 cm, ˜1.9 cm, ˜2.0 cm, ˜2.25 cm, ˜2.50 cm, or a diameter or width that falls within a range lying between any two of the aforementioned heat transfer channel widths (e.g., a diameter or width that is between ˜0.05cm and ˜1.0 cm). In some embodiments, the flow paths formed by the interconnected porous network of the foam components have widths that vary along the path. In some embodiments, the flow paths formed by the interconnected porous network have a maximum width that is equal to or less than ˜5 mm, that is equal to or less than ˜4 mm, that is equal to or less than ˜3 mm, that is equal to or less than ˜2 mm, that is equal to or less than ˜1 mm, that is equal to or less than ˜0.9 mm, that is equal to or less than ˜0.8 mm, that is equal to or less than ˜0.7 mm, that is equal to or less than ˜0.6 mm, that is equal to or less than ˜0.5 mm, that is equal to or less than ˜0.4 mm, that is equal to or less than ˜0.3 mm, that is equal to or less than ˜0.2 mm, that is equal to or less than ˜0.1 mm, that is equal to or less than ˜0.09 mm, that is equal to or less than ˜0.05 mm, that is equal to or less than ˜0.01 mm, that is equal to or less than ˜0.009 mm, that is equal to or less than ˜0.005 mm, that is equal to or less than ˜0.001 mm, that is equal to or less than ˜0.0009 mm, that is equal to or less than ˜0.0005 mm, that is equal to or less than ˜0.0001 mm, that is equal to or less than 0.00009 mm, that is equal to or less than 0.00005 mm, that is equal to or less than 0.00001 mm, or that falls within a range lying between any two of the aforementioned flow path widths of the interconnected porous network (e.g., a diameter or width that is between ˜0.05 mm and ˜0.1 mm).

Interconnected porous network 554 and heat transfer channels 552 form pathways through and along foam component 508 that provide a means for the flow of heat transfer fluid through solar absorption chamber 520. For example, when heat transfer fluid is flowing from solar absorption chamber 520 to the heat storage component, the heat transfer fluid will first flow through interconnected porous network 554 to traverse the width of foam component 508. Once the heat transfer fluid has traversed foam component 508, the heat transfer fluid will then flow through heat transfer channels 552 towards heat transfer fluid line 516 and the heat storage component.

In some embodiments, the portions of the foam component defining or bordering the reactor chambers are devoid of interconnected pores so as to prevent or reduce the flow of the heat transfer fluid into the reactor chambers. In other embodiments, the interconnected porous network extends through the portions of the foam component defining or bordering the reactor chambers so as to allow the heat transfer fluid to pass into the reactor chambers and/or make direct physical and thermal contact with the reactors positioned within the reactor chambers.

As can be seen in the cross-sectional view of FIG. 5B, outer tubular wall 505 of insulative component 506 has a cross-sectional shape that is generally circular. In other embodiments, the outer wall of the insulative components of the present invention may have a different cross-sectional shape. For example, the outer wall of the insulative components, in some embodiments, have a cross-sectional shape that is square, rectangular, triangular, hexagon, or some other rectilinear shape.

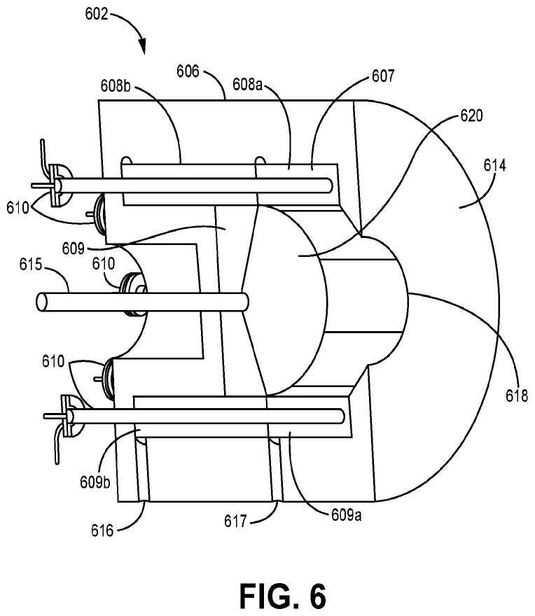

FIG. 6 illustrates a side cut-away perspective view of a portion of another embodiment of the present invention in the form of solar assembly 602. Solar assembly 602 includes insulative component 606, foam components 608a and 608b, and a plurality of chemical reactors 610.

Insulative component 606 defines insulated receptacle 607, including most of the sunward side of insulated receptacle 607. Foam components 608a and 608b and block component 609 are positioned within insulated receptacle 607. Sunward face 614 of insulative component 606 defines aperture 618. Solar absorption chamber 620 is at least partially defined by aperture 618, foam component 608, and block component 609.

Solar assembly 602 includes heat transfer lines 615, 616, and 617. Heat transfer line 615 extends along the major axis of insulative component 606 and is defined at least in part by insulative component 606 and block component 609. Heat transfer line 616 extends through the lateral wall of insulative component 606 and is in fluid communication with insulated receptacle 607 near back portion 609b of foam component 608b. Heat transfer line 617 extends through the lateral wall of insulative component 606 and is in fluid communication with insulated receptacle 607 near back portion 609a of foam component 608a.

During operation, in some embodiments, aperture 618 will be open to the atmosphere if solar radiation is plentiful (e.g., during the day) and heat transfer fluid lines 615 and 617 will be closed or otherwise occluded (e.g., via a valve or plug; not illustrated in FIG. 6). Solar radiation and heat transfer fluid (e.g., air) will enter solar absorption chamber 620 via aperture 618. The solar radiation will insolate block component 609 and/or the inner side walls of foam component 608a, and thereby heat solar absorption chamber 620. The heat transfer fluid in solar absorption chamber 620 will in turn also be warmed by the heat generated from such insolation. Foam components 608a and 608b each define interconnected porous networks. The hot heat transfer fluid in solar absorption chamber 620 will be directed into and through the interconnected porous network defined by foam component 608a. As the hot heat transfer fluid passes through the interconnected porous network of foam component 608a, the hot heat transfer fluid will warm the portions of reactors 610 that extend through foam component 608a. The hot heat transfer fluid will then be directed into and through the interconnected porous network defined by foam component 608b and heat the portions of reactors 610 that extend through foam component 608b. Depending upon the demands of a given application, the hot heat transfer fluid will cool slightly as it travels through foam components 608a and 608b. Because the hot heat transfer fluid passes through foam component 608a before foam component 608b, the heat transfer fluid may have a higher temperature when passing through the interconnected porous network defined by foam component 608a as compared to the temperature of the heat transfer fluid in the interconnected porous network defined by foam component 608b. Hence, the portions of reactors 610 that extend through foam component 608a may be heated more and attain a higher operating temperature than the portion of reactors 610 that extend through foam component 608b. Further, the portions of reactors 610 that extend through insulative component 606 or that extend out of the back wall of insulative component 606 are not warmed directly by the heat transfer fluid flowing through insulated receptacle 607 and therefore those portions of reactors 610 may operate at a lower temperature than either of the portions of reactors 610 that are positioned within foam components 608a or 608b. After travelling through the interconnected porous networks defined by foam component 608a and 608b, the heat transfer fluid is then directed through heat transfer fluid line 616 and to the heat storage component (not illustrated in FIG. 6). In this way, the inventive system provides for the transmission of heat to reactors 610 by both conduction (as heat conducts through foam components 608a and 608b) and convection (as heat transfer fluid flows through foam components 608a and 608b).

During operation when solar radiation is plentiful, aperture 618 will be open to the atmosphere and heat transfer fluid lines 615 and 616 will be closed or otherwise occluded (e.g., via a valve or plug; not illustrated in FIG. 6). The hot heat transfer fluid in the solar absorption chamber 620 will be directed into and through the interconnected porous network defined by foam component 608a, but instead of traveling through the interconnected porous network defined by foam component 608b, the heat transfer fluid will leave solar assembly 602 via heat transfer fluid line 617 and be directed towards the heat storage component.

Alternatively, during operation when solar radiation is not plentiful (e.g., at night or during inclement weather), aperture 618 will be closed (e.g., by a plug; not illustrated in FIG. 6) to the atmosphere, heat transfer fluid lines 615 and 616 will be opened, and heat transfer fluid line 617 will be closed or otherwise occluded (e.g., via a valve or plug; not illustrated in FIG. 6). Heat transfer fluid (e.g., atmospheric air) will be directed through the heat storage component to produce hot heat transfer fluid. The hot heat transfer fluid will then be directed through heat transfer fluid line 615 and into solar absorption chamber 620. The hot heat transfer fluid will then be directed into and through the interconnected porous network defined within foam component 608a where the hot heat transfer fluid will warm the portion of reactors 610 that extend through foam component 608a. The hot heat transfer fluid will then be directed into and through the interconnected porous network defined within foam component 608b where the heat transfer fluid will warm the portion of reactors 610 that extend through foam component 608b. The heat transfer fluid will then exit the interconnected porous network defined within foam component 608b and be directed out of assembly 602 via heat transfer fluid line 616. Subsequently, the heat transfer fluid may be vented to the atmosphere or recycled back to the heat storage component for reuse in the inventive system.

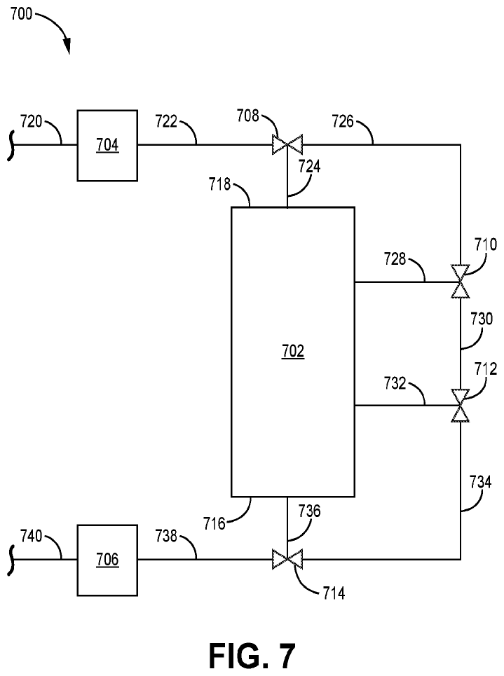

FIG. 7 illustrates a schematic representation of one embodiment of the present invention in the form of heat storage system 700. Heat storage system 700 includes heat storage component 702, bi-directional blowers 704 and 706, and valves 708, 710, 712, and 714. Heat storage system 700 also includes heat transfer fluid lines 720, 722, 724, 726, 728, 730, 732, 734, 736, 738, and 740.

Heat storage component 702 is generally cuboid in shape and includes first end 718 and second end 716. While heat storage component 702 is shown in FIG. 7 as being generally rectangular in shape, in other embodiments, the heat storage components of the present invention are formed into cylindrical, cubic, conical, prismatic (e.g., triangular prismatic or pentagonal prismatic, or hexagonal prismatic), or cylindrical shapes.

Heat storage component 702 could be, for example, a sensible heat storage system or component, such as one with an insulated bed or tank packed with a heat storage material that can store relatively large amounts of heat and withstand the operating temperatures of the desired application. In some embodiments, the heat storage material includes aluminum oxide particles that are sufficiently sized to allow heat transfer fluid to flow between the particles when the particles are arranged or otherwise packed in heat storage component 702. In further embodiments, the heat storage components of the present invention include a particle-based heat storage system or component, a thermochemical energy storage media, or a phase-change heat storage system or component.

During operation of an inventive system when solar radiation is plentiful, heat transfer fluid is warmed in a solar assembly and directed to heat storage system 700 to store the heat present in the heat transfer fluid. Blower 704 and/or blower 706 are used to create a pressure gradient in the heat transfer fluid lines that provide for fluid communication between heat storage component 702 and the inventive solar assembly, thereby directing warmed heat transfer fluid through lines 720, 722 and 724 and into first end 718 of heat storage component 702. Once in heat storage component 702, the warmed heat transfer fluid will flow between and over the heat storage material within heat storage component 702 and heat the heat storage material. As the heat storage material traverses the length of heat storage component 702 and passes out of heat storage component via lines 736, 738 and 740, after which the now relatively cold heat transfer fluid will be directed back to the solar assembly to be heated again, be vented to the atmosphere, or be directed to another application of interest.

As the hot heat transfer fluid passes through the heat storage material in heat storage component 702, the heat storage material nearest first end 718 will be warmed to a temperature that is higher than the heat storage material nearest second end 716. A temperature gradient will be created across the length of heat storage component 702, with higher temperatures near first end 718, lower temperatures near second end 716, and intermediate temperatures therebetween. Further, a thermocline may be established within heat storage component 702, with the thermocline moving from first end 718 towards second end 716 as the hot heat transfer fluid continues to charge the heat storage material with additional heat.

During operation of an inventive system when solar radiation is not plentiful, relatively cold heat transfer fluid is warmed by heat storage system 700 and directed to the solar assembly for use in heating the plurality of chemical reactors. Blower 704 and/or blower 706 are reversed in direction to direct relatively cold heat transfer fluid (e.g., air from the atmosphere or spent heat transfer fluid from the solar assembly) through lines 740, 738 and 736 and into heat storage component 702. As the cold heat transfer fluid passes through heat storage component 702, the heat transfer fluid is warmed by the heat storage material. The now hot heat transfer fluid exists heat storage component 702 via lines 724, 722, and 720 and is directed to the solar assembly to warm the plurality of reactors. Once the heat transfer fluid has been used by the solar assembly to warm the plurality of reactors, it may be vented to the atmosphere, directed back to heat storage system 700 to be re-heated, or directed to another application of interest.

As the relatively cold heat transfer fluid passes through the heat storage material in heat storage component 702, the heat storage material nearest second end 716 will be cooled to a temperature that is lower than the heat storage material nearest first end 718. The thermocline within heat storage component 702 may move from second end 716 towards first end 718 as the heat storage material continues to charge the heat transfer fluid with additional heat.

In some applications, it may be advantageous to direct heat transfer fluid into heat storage component 702 at one or more points along the length of heat storage component 702 that are intermediate to first and second ends 718, 716. For example, it may be desirable to direct heat transfer fluid at a point that is on the cold or warm side of the thermocline in heat storage component 702. In those embodiments, valves 708, 710, 712, and/or 714 can be manipulated to direct heat transfer fluid through one or more of lines 726, 728, 730, 732, and 734 to introduce the heat transfer fluid at a desired point along the length of heat storage component 702. For example, thermocouples may be mounted within heat storage component 702 to monitor the position of a thermocline therein and electronic controllers can use those temperature measurements to control valves 708, 710, 712, and/or 714 and provide for the direction of heat transfer fluid into component 702 at a desired point intermediate to first and second ends 718 and 716. Valves 708 and/or 714 can be actuated to control the flow of heat transfer fluid in heat transfer fluid lines 720 and 740, respectively, thereby controlling whether heat transfer fluid can leave or enter a solar assembly of the invention via lines 720 and 740

While FIG. 7 illustrates system 700 as having two possible points intermediate first and second ends 718, 716 (i.e., through lines 728 or 732), in other embodiments of the invention the heat storage systems include additional lines and valves to facilitate 3, 4, 5, 6, 7, 8, 9, 10, 11, 12, 13, 14, 15, 16, 17, 18, 19, 20, 21, 22, 23, 24, or more than 24 points where heat transfer fluid can be directed into heat storage component intermediate to the first and second ends.

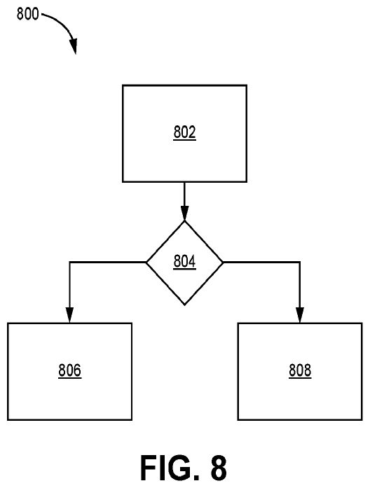

The present invention includes methods of heating a reactor. FIG. 8 illustrates a schematic flow chart of one embodiment of the invention in the form of method 800, which is a method of heating a reactor.

At 802, method 800 includes providing a system for controlling the temperature of a chemical reactor. The system provided may be any of the inventive systems described herein. For example, the system may include a foam component, an insulative component, a solar absorption chamber, a reactor chamber, a heat storage component, and a heat transfer fluid. The insulative component defines at least a portion of an insulated receptacle, and the foam component is positioned in the insulated receptacle. At least a portion of the solar absorption chamber is defined by the foam component and an aperture, wherein the aperture is configured to allow solar radiation to enter the solar absorption chamber. The foam component defines at least a portion of the reactor chamber and the reactor chamber includes a higher temperature end and a lower temperature end, with the higher temperature end positioned closer to the solar absorption chamber than the lower temperature end. The reactor can be positioned in the reactor chamber. The heat transfer fluid can be in fluid communication with the solar absorption chamber and the heat storage component.

At 804, method 800 includes determining if a desired amount of solar radiation is available.

If a desired amount of solar radiation is available, then at 806 method 800 includes directing the solar radiation through the aperture and into the solar absorption chamber to heat the foam component. Also, at 806, method 800 includes directing the heat transfer fluid through the foam component to heat the reactor and the heat transfer fluid. Further, at 806 method 800 includes directing the heat transfer fluid to the heat storage component and heating the heat storage component with the heat transfer fluid.

If a desired amount of solar radiation is not available, then at 808 method 800 includes heating the reactor and the heat transfer fluid with the heat storage component.

In some embodiments of the inventive methods, heating the reactor and the heat transfer fluid with the heat storage component includes directing the heat transfer fluid into thermal contact with the heat storage component to form a hot heat transfer fluid and directing the hot heat transfer fluid into the foam component to heat the reactor. In further embodiments of the inventive methods, directing the hot heat transfer fluid into the foam component includes directing the hot heat transfer fluid through a heat transfer fluid line. In still further embodiments of the inventive methods, an insulative plug is positioned within the aperture to prevent heat transfer fluid from passing through the aperture. In even further embodiments of the inventive methods, heating the reactor and the heat transfer fluid with the solar radiation includes directing the solar radiation through the aperture to heat the foam component. In further embodiments of the inventive method, the methods include directing heat transfer fluid through the foam component to form a hot heat transfer fluid and directing the hot heat transfer fluid to the heat storage component.

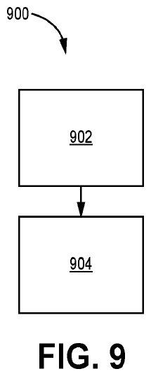

The present invention also includes methods of making the systems or parts of the systems described herein. For example, the present invention includes a method of manufacturing a system for controlling the temperature of a chemical reactor. FIG. 9 illustrates such a method in the form of method 900. At 902, method 900 includes using a manufacturing process to make one or more of the various components of the inventive systems that have been described herein using one or more of the suitable materials described herein for such component(s). At 904, method 900 includes assembling the various components of the inventive systems that were manufactured in part 902 of method 900 to provide a finished inventive system according to one or more of the embodiments described herein.

The materials of construction used to make the various components of the inventive systems can be chosen based upon the demands and performance characteristics required for a given application. Some factors that should be considered in choosing materials of construction include thermal stability, chemical reactivity, thermal conductivity, resistance to cracking, and cost. In some embodiments, the solar absorption chambers, foam and insulative components, and reactors may operate with, and are made of material(s) that can withstand, internal operating temperatures of between about 50°° C. and about 2,000° C.

In some embodiments, the portions of the inventive systems are made of a metal or a metal alloy (e.g., a stainless steel alloy, such SS316, or a chromium nickel alloy, such as 800HT and/or TMA6301), a ceramic material, a ceramic composite material, or combinations thereof. Silicon carbide, aluminosilicate, aluminum nitride, aluminum oxynitride, and/or alumina, for example, can be used to form some or all of the components of the inventive systems. Silicon carbide is a relatively strong material with advantageous thermal conductivity properties. Silicon carbide also has relatively low gas permeability and excellent chemical stability, a low thermal expansion coefficient, and is resistant to fracture and crack propagation.

In some embodiments, some or all of the components of the inventive systems are made of two or more materials to better accommodate the temperature gradient that may span portions of the system. For example, some components of the inventive systems (e.g., foam components or the materials defining the solar absorption chambers) may operate at relatively high temperatures (e.g., 700° C.-1.600° C.) while other portions of the inventive systems may operate at relatively low temperatures (e.g., 50° C.-400° C.). The portions of the system that will be exposed to the relatively high temperatures can be formed from a material that is better able to handle those higher temperatures (e.g., a ceramic material or a ceramic composite material, such as silicon carbide), while portions that are exposed to the relatively low temperatures may be made of materials that do not need to withstand those higher temperatures (e.g., a metal or metal alloy). For example, portions of the system that will be exposed to relatively low temperatures may be formed of a metal or metal alloy, while portions of the system that will be exposed to relative high temperatures may be formed of silicon carbide material, a silicon carbide composite, alumina, aluminosilicate, aluminum nitride, aluminum oxynitride, or combinations thereof.

Further, some portions of the inventive systems may be coated, lined, or impregnated with a second material so as to impart improved operating performance and/or endurance to the reactor. For example, all or some portion (e.g., a distal portion) of a solar assembly or a heat storage component may include a lining or coating of aluminide, alumina, an alumina/silicon carbide composite material, a boron nitride material, mullite, a silicon nitride material, a rare-earth silicate material, or a rare-earth aluminate material.

Manufacturing methods useful for making the various components of the inventive systems include machining, casting, molding, forming, joining, plating, isopressing, extruding, or additive manufacturing methods (e.g., binder jet 3D printing methods, extrusion 3D printing methods, stereolithography methods, robocasting methods, or selective laser sintering methods). Further, methods such as solid-state sintering, liquid-phase sintering, reactive melt infiltration, chemical vapor infiltration, and phenolic impregnate pyrolysis can be used to consolidate printed preforms into dense, usable parts of the inventive system.

A 3D printing process can be used to print all or portions of the components of the inventive systems using one or more different types of materials. For example, a 3D printing process can be used to print two or more portions of a foam component out of silicon carbide and then the two or more portions can be joined together (e.g., via sintering, adhesives or glue, or welding) to create the finished foam component. In another example, a 3D printing process can be used to print a first portion of system component out of silicon carbide and a second portion out of a metal alloy and then the two portions are welded or otherwise adhered together to form the complete component. A 3D printing process that utilizes two or more materials and can vary the ratio of those materials across the dimensions of a workpiece can also be useful in creating the components of the inventive systems.

The scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

1. A system for controlling the temperature of a chemical reactor, the system comprising:
a solar assembly that includes
a foam component,
an insulative component defining at least a portion of an insulated receptacle, wherein the foam component is positioned in the insulated receptacle,
a solar absorption chamber, wherein at least a portion of the solar absorption chamber is defined by the foam component and an aperture, wherein the aperture is configured to allow solar radiation to enter the solar absorption chamber,
a reactor chamber, wherein the foam component defines at least a portion of the reactor chamber,
a reactor positioned in the reactor chamber;
a heat storage component, wherein the solar absorption chamber is in fluid communication with the heat storage component;
a heat transfer fluid line that is in fluid communication with both the insulated receptacle and the heat storage component; and
a heat transfer fluid.

2. The system of claim 1, wherein the heat transfer fluid line is configured to direct the heat transfer fluid from the insulated receptacle to the heat storage component.

3. The system of claim 2, further including a second heat transfer fluid line configured to direct the heat transfer fluid from the heat storage component to the insulated receptacle.

4. The system of claim 2, further including a valve configured to prevent the flow of the heat transfer fluid from the heat storage component to the insulated receptacle when solar radiation is entering the solar absorption chamber.

5. The system of claim 2, further including a valve configured to prevent the flow of the heat transfer fluid from the insulated receptacle to the heat storage component when solar radiation is not entering the solar absorption chamber.

6. The system of claim 1, wherein the foam component defines an interconnected porous network configured to direct heat transfer fluid from the solar absorption chamber and through the foam component.

7. The system of claim 1, wherein the foam component defines at least portions of a heat transfer fluid channel configured to direct heat transfer fluid from the insulated receptacle to the heat transfer fluid line.

8. The system of claim 7, wherein insulative component defines at least a portion of the heat transfer fluid channel.

9-10. (canceled)

11. The system of claim 1, further including a blower configured to direct the heat transfer fluid through the heat transfer fluid line.

12. The system of claim 11, wherein the heat transfer fluid is air and wherein the blower is configured to draw the heat transfer fluid through the aperture and into the solar absorption chamber.

13. The system of claim 1, wherein the insulative component defines at least a portion of the reactor chamber, at least a portion of the solar absorption chamber, and at least a portion of the aperture.

14. The system of claim 1, wherein the aperture is configured to allow atmospheric air to enter the solar absorption chamber.

15. The system of claim 1, further including an insulative plug configured to be positioned within the aperture to prevent heat transfer fluid from passing through the aperture.

16. The system of claim 1, wherein the solar assembly defines a plurality of reactor chambers.

17-20. (canceled)

21. The system of claim 1, wherein the heat storage component includes a sensible heat storage component, a particle-based heat storage component, a thermochemical energy storage media, or a phase-change heat storage component.

22. The system of claim 21, wherein the heat storage system is a sensible heat storage system that includes a packed bed, and wherein the packed bed includes a hot end and a cold end, and wherein the packed bed includes a packing material that is thermally stratified between the hot end and the cold end.

23. A method of heating a reactor, the method comprising:
providing a system for controlling the temperature of a chemical reactor according to claim 1;
when solar radiation is available, heating the reactor by
directing the solar radiation through the aperture to insolate and heat the solar absorption chamber,
directing heat transfer fluid through the aperture and into the solar absorption chamber,
directing the heat transfer fluid from the solar absorption chamber and through the foam component to heat the reactor, and
directing the heat transfer fluid from the foam component and to the heat storage component to heat the heat storage component with the heat transfer fluid; and
when solar radiation is not available, heating the reactor by
directing the heat transfer fluid to the heat storage component to heat the heat transfer fluid,
directing the heat transfer fluid to the solar assembly from the heat storage component and through the foam component to heat the reactor.

24. The method of claim 23, wherein directing the solar radiation through the aperture includes insolating and heating the foam component.

25. The method of claim 23, wherein directing the heat transfer fluid from the foam component and to the heat storage component includes directing the heat transfer fluid through a heat transfer fluid channel, wherein the heat transfer fluid channel is at least partially defined by the foam component.

26-35. (canceled)

36. A method of manufacturing a system for controlling the temperature of a chemical reactor according to claim 1.

37-40. (canceled)
